(19) United States
(12) Patent Application Publication
(10) Pub. No.: US 2008/0113531 A1
(43) Pub. Date: May 15, 2008

(54) Electrical connector

(75) Inventor: Ted Ju, Keelung (TW)

Correspondence Address: BIRCH STEWART KOLASCH & BIRCH, PO BOX 747, FALLS CHURCH, VA, 22040-0747, US

(73) Assignee: Lotes Co., Ltd.

(21) Appl. No.: 11/599,448

(22) Filed: Nov. 15, 2006

(51) Int. Cl. H01R 12/00

(52) U.S. Cl. 439/83

(57) ABSTRACT

The invention relates to an electrical connector for electrically connecting to a circuit board. The electrical connector includes an insulating base, a conductive terminal accommodated in the insulator, and an end of the conductive terminal having a leading portion for connecting a soldering block. A plurality of supporting members are placed at a bottom surface of the insulating base, the height of the supporting members is variable, and the supporting members together with the soldering blocks are used for supporting the electrical connector. The electrical connector can reduce the gap formed between the conductive terminals and prevent deformation of the electrical connector, so the connecting electronic component connected to the electrical connector have good electrical connection with the circuit board.

### BACKGROUND OF THE INVENTION

1. Field of the Invention

The invention relates to an electrical connector and, more particularly, to an electrical connector capable of being soldered to a circuit board.

2. Description of the Prior Art

As shown in FIG. 1 and FIG. 2, a conventional electrical connector 10 capable of being soldered to a circuit board 40 usually includes an insulating base 20 defining a plurality of terminal slots (not shown) for accommodating conductive terminals (not shown), and downward ends of the conductive terminals having soldering blocks 30 for soldering to the circuit board 40; the electrical connection between the electrical connector 10 and the circuit board 40 has therefore been established.

The soldering blocks 30 on the bottom surface of the insulating base 20 are usually solder balls, due to the gravity of the insulating base 20, the heights of the soldering blocks 30 vary with the melting of the solder balls during high-temperature soldering process, thus cause the insulating base 20 slants to one side. As a result, the whole electrical connector 10 slants and forming a gap between the electrical connector 10 and the circuit board 40, this gap affects the soldering of the electrical connector 10 as some of conductive terminals cannot be soldered to the circuit board 40, therefore, the electrical connection between the electrical connector 10 and the circuit board 40 is affected. Moreover, the slant of the electrical connector 10 will cause the deformation of the connecting surface, and affects the smoothness of the connecting surface between the electrical connector 10 and relative connecting electronic component. Accordingly, the electrical connector 10 and the connecting electronic component cannot be well mated, and consequently, the electrical connection between the electrical connector 10 and the connecting electronic component will be affected as well.

The electrical connector 10 mentioned above, is one of examples in the prior art. In other examples, supporting members are introduced, but the height of the supporting members is fixed and do not vary with the melting of the solder. Consequently, a gap is easily formed between the electrical connector 10 and the circuit board 40.

It is with respect to these and other considerations that the present invention has been made to overcome the problems exist in the prior art.

### SUMMARY OF THE INVENTION

In accordance with the present invention, the above mentioned problems are solved by an improved electrical connector for reducing the gap between the electrical connector and the circuit board, and preventing the deformation of the connecting surface, so as to enhance the electrical connection.

According to a preferred embodiment of the present invention, an electrical connector for electrically connecting to a circuit board includes an insulating base, a plurality of conductive terminals accommodated in the insulating base, one end of the each conductive terminal having a leading portion for connecting with a soldering block; a plurality of supporting members are set on the bottom surface of the insulating base, the height of the supporting members is variable, and the supporting members together with the soldering blocks are used for supporting the electrical connector.

An advantageous feature of the present invention is that the electrical connector can reduce the gap formed between the electrical connector 10 and circuit board 40, so as to prevent the electrical connector from deformation of its connecting surface, enhance the electrical connection between the circuit board and the electronic component.

It is to be understood that the advantages and spirit of the present invention will be apparent from a reading of foregoing general description and the following detailed description, together with a review of the appended drawings.

### BRIEF DESCRIPTION OF THE APPENDED DRAWINGS

FIG. 1 is a lateral view of the insulating base of an electrical connector of the prior art.

FIG. 2 shows the gap between an electrical connector of the prior art and a circuit board.

FIG. 3 is a front view of an electrical connector of the present invention.

FIG. 4 is a rear view of an electrical connector of the present invention.

FIG. 5 is a lateral view of the insulating base of an electrical connector of the present invention.

FIG. 6 shows a terminal slot.

FIG. 7 shows an electrical connector of the present invention and a circuit board before being soldered together.

FIG. 8 shows an electrical connector of the present invention and a circuit board after being soldered together.

FIG. 9 shows a bottom surface of an electrical connector without supporting members.

FIG. 10 shows a bottom surface of an electrical connector with supporting member accommodated in a square slot.

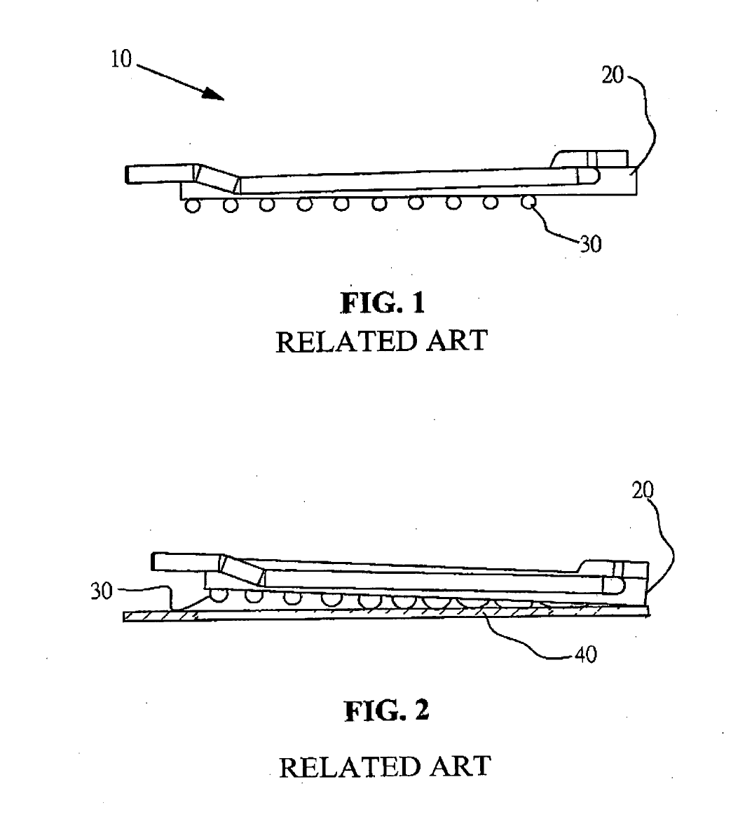

### DETAILED DESCRIPTION OF THE INVENTION

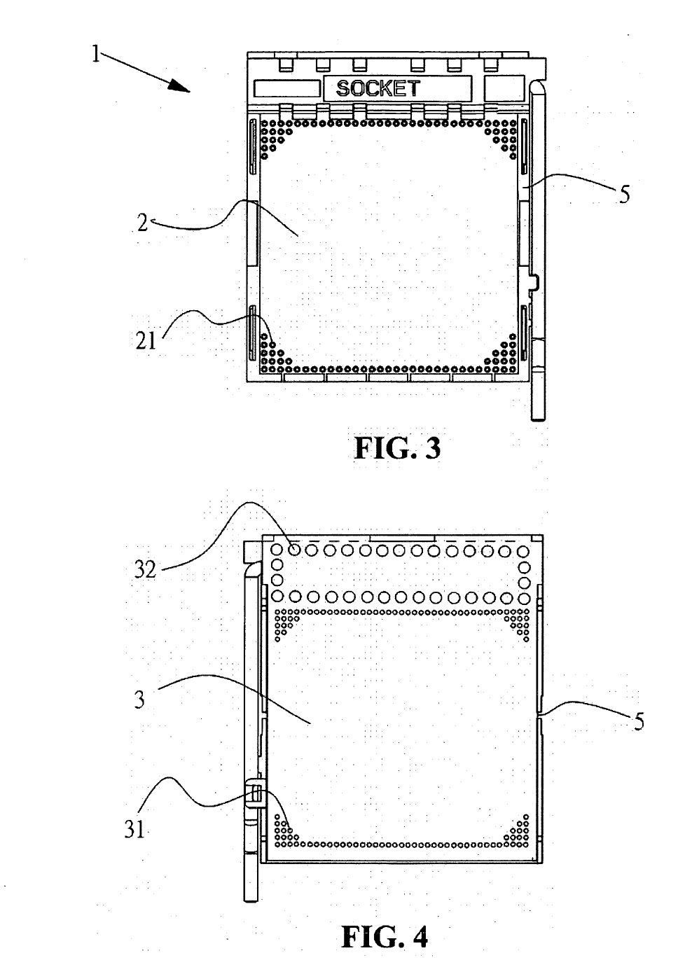

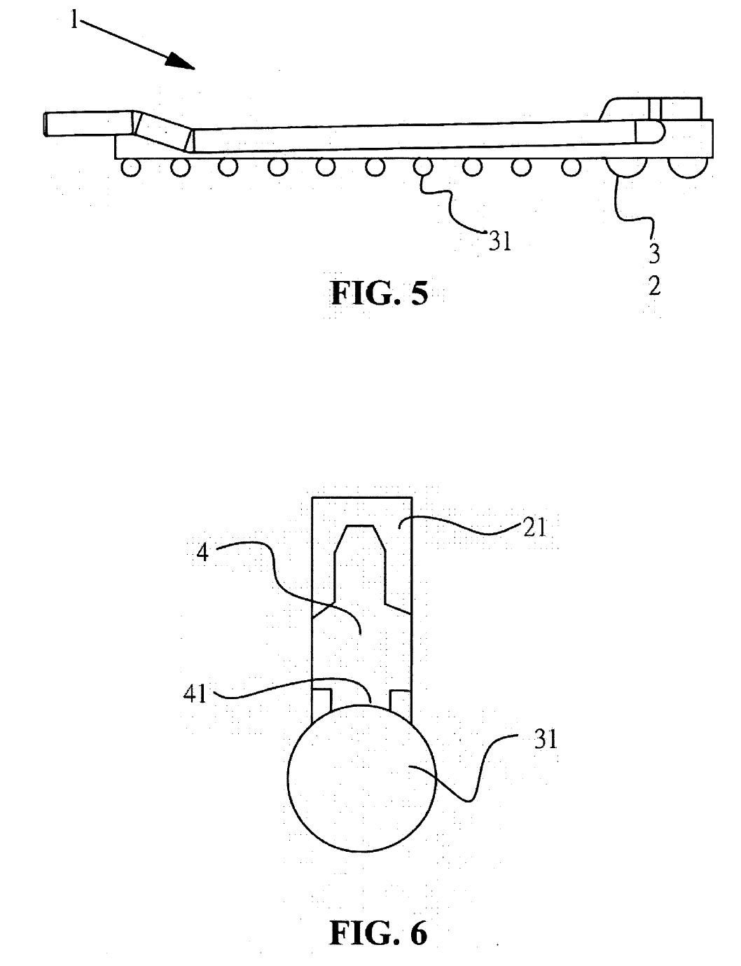

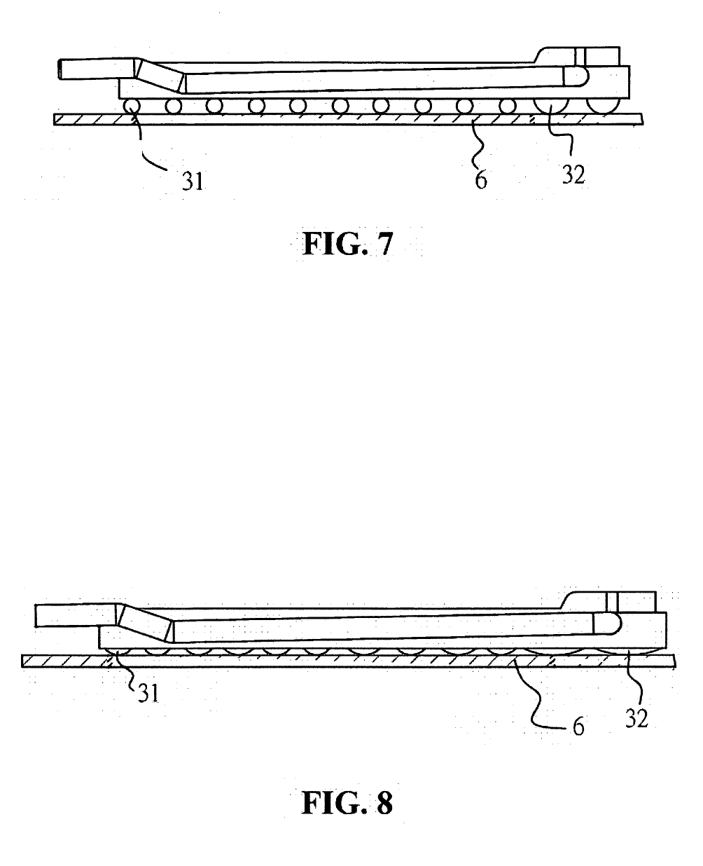

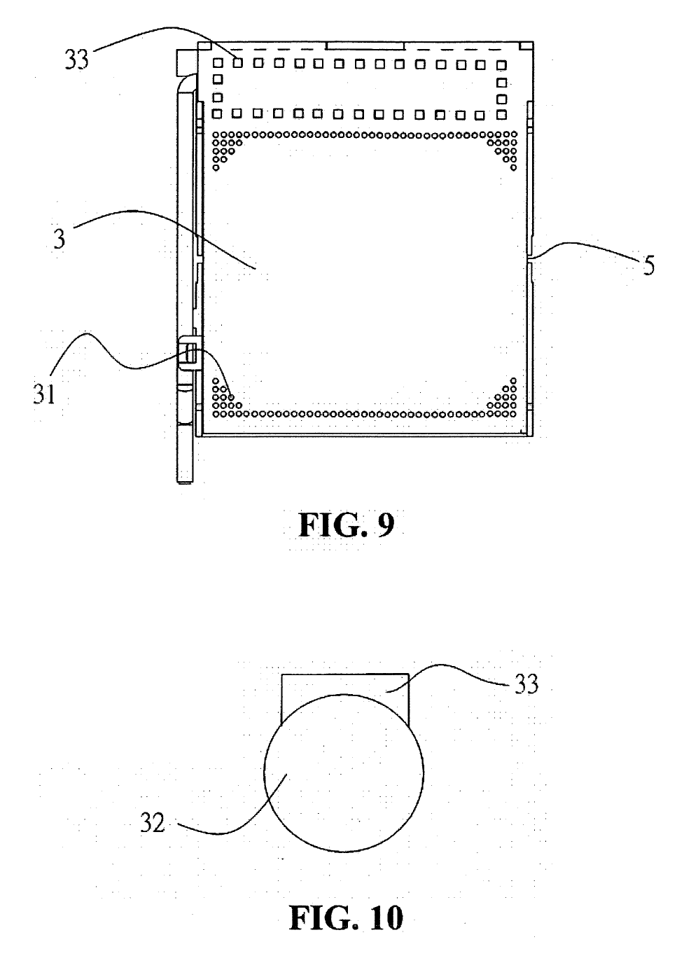

Referring to FIG. 3 through FIG. 9, an electrical connector 1 of the present invention includes an insulating base 5 defining a top surface 2 and a bottom surface 3. The top surface 2 is used for connecting with a connecting electronic component (CPU module in this embodiment, not shown); the bottom surface 3 is used for being soldered to a circuit board 6.

The insulating base 5 has a plurality of terminal slots 21 formed through the top and bottom surfaces of the insulating base 5. The terminal slots are used for accommodating conductive terminals 4. An upper end of the conductive terminal 4 is used for connecting with the connecting electronic component, and a lower end of the conductive terminal 4 has a leading portion 41 for connecting with a soldering block 31, and the soldering block 31 is a solder ball protruding downward out of the bottom surface 3 of the insulating base 5.

Supporting members 32 are solder balls. Beside terminal slots 21 on one side of the bottom surface 3, on the other side of the bottom surface 3 are square slots 33 for receiving and fixing the supporting members 32.

The electrical connector 1 is fixed onto the circuit board 6 via the conjunction of the soldering blocks 31 and the solder pads (not shown) on the circuit board. When the electrical connector 1 is positioned horizontally parallel onto the circuit board 6, the lower end of the soldering blocks 31 and the lower end of the supporting member 32 are on the same plane with respect to the circuit board 6.

In the process of soldering the electrical connector 1 together with the circuit board 6, firstly, the electrical connector 1 is positioned onto the circuit board 6 with the support of the soldering blocks 31 and the supporting members 32. Under high soldering temperature environment, the soldering blocks 31 and the supporting members 32 will melt, with the effect of gravity from both the insulating base 5 and the soldering blocks 31, the soldering blocks 31 conjoin with the corresponding solder pads (not shown) on the circuit board 6; the melting points of both the soldering blocks 31 and the supporting members 32 are almost the same, so they melt at approximately the same time under the same high-temperature environment, accordingly, the variations of the height of both the supporting members 32 and the solders 31 are also approximately the same, so the insulating base 5 and the whole electrical connector 1 will maintain balance under the support of both the soldering blocks 31 and supporting members 32, after cool down from the high soldering temperature, the soldering blocks 31 are completely soldered with the circuit board 6, so as to mate the electrical connector 1 with the circuit board 6 and establish good electrical connection in between.

Because of the supporting members 32 provide good support for the electrical connector, and the height of supporting members 32 is variable, it could maintain balance of the electrical connector 1, and the soldering blocks 31 and the supporting members 32 are on the same plane with respect to the circuit board 6, thus reduce the gap formed between the electrical connector 1 and the circuit board 6, and eliminate the deformation of the connecting area, ensure the smoothness of the connecting surface between the electrical connector 1 and the connecting electronic component.

According to the present invention, the soldering blocks 31 and the supporting members 32 can be solder balls, solder lumps, or other metals or metalloids having variable heights capable of varying with temperature.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

1. An electrical connector for electrically connecting to a circuit board, comprising:
an insulating base;
a plurality of conductive terminals, one end of each of the conductive terminals having a leading portion for connecting with a soldering block;
a plurality of terminal slots for accommodating the conductive terminals; and
a plurality of supporting members being placed on a bottom surface of the insulating base and accommodated in at least one accommodating slot of the insulating base the height of each supporting member being variable, and the supporting members together with the soldering blocks being used for supporting the electrical connector.

2. (canceled)

3. The electrical connector of claim 1, wherein the soldering block is a solder ball.

4. The electrical connector of claim 1, wherein the supporting members are solder balls.

5. The electrical connector of claim 1, wherein the supporting members are placed on one side of the bottom surface of the insulating base.

6. The electrical connector of claim 1, wherein the lower ends of both the supporting members and the soldering blocks are on the same plane.

7. The electrical connector of claim 1, wherein a plurality of solder pads are provided on the circuit board for cooperating with soldering blocks and without the supporting members.
